(19) United States
(12) Patent Application Publication
(10) Pub. No.: US 2026/0050098 A1
(43) Pub. Date: Feb. 19, 2026

(54) SYSTEM AND METHOD FOR ELASTIC FULL WAVEFORM INVERSION OF HYDROPHONE DATA

(71) Applicant: Chevron U.S.A. Inc., San Ramon, CA (US)

(72) Inventors: Peng Shen, Houston, TX (US); Uwe K. Albertin, Houston, TX (US); Hermes Malcotti Isern, Houston, TX (US); Joshua Ian Haataja, Houston, TX (US)

(21) Appl. No.: 19/303,104

(22) Filed: Aug. 18, 2025

Related U.S. Application Data
(60) Provisional application No. 63/684,662, filed on Aug. 19, 2024.

(51) Int. Cl. G01V 1/34; G01V 1/38

(52) U.S. Cl. CPC G01V 1/345; G01V 1/38; G01V 2210/6242; G01V 2210/74

(57) ABSTRACT

A method is described for elastic full waveform inversion of hydrophone seismic data that produces an earth model that can be used for seismic imaging. The elastic full waveform inversion uses a P-wave velocity (Vp)-S-wave velocity (Vs)-density (ρ) parameterization. The method does not use any prior well-log information. The method is executed by a computer system.

### CROSS-REFERENCE TO RELATED APPLICATIONS

This application claims the benefit of U.S. Provisional Patent Application 63/684,662 titled “System And Method For Elastic Full Waveform Inversion of Hydrophone Data” filed Aug. 19, 2024.

### STATEMENT REGARDING FEDERALLY SPONSORED RESEARCH OR DEVELOPMENT

Not applicable.

### TECHNICAL FIELD

The disclosed embodiments relate generally to techniques for seismic imaging of subsurface reservoirs for the purpose of hydrocarbon exploration and production and, in particular, to a method of elastic full waveform inversion applied to seismic data for improved velocity model construction to be used in seismic imaging.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. This process may include determining the velocities of the subsurface formations in order to perform the imaging. Determining the velocities may be done by a number of methods, such as semblance analysis, tomography, or full waveform inversion. Full waveform inversion (FWI) is a computationally expensive process that is often limited to determining just the P-wave velocity (V_{P}) to make it computationally feasible. Improved seismic images from improved subsurface velocities allow better interpretation of the locations of rock and fluid property changes. The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for more accurate FWI methods to allow better seismic imaging that will in turn allow better seismic interpretation of potential hydrocarbon reservoirs.

### SUMMARY

In accordance with some embodiments, a method of elastic full waveform inversion of hydrophone seismic data is disclosed. The full waveform inversion is an elastic full waveform inversion using a P-wave velocity (Vp)-S-wave velocity (Vs)-density (ρ) parameterization. The elastic full waveform inversion generates a 3D model of physical properties of a subsurface volume of interest.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows results of the present invention, in accordance with some embodiments, and includes 4 panels, (a), (b), (c), and (d);

FIG. 2 is a comparison of far offset stack and the inverted density from elastic FWI in depth slice, in accordance with some embodiments, and includes two panels (a) and (b);

FIG. 3 shows results of the present invention, in accordance with some embodiments, and includes 4 panels, (a), (b), (c), and (d);

FIG. 4 compares an initial model and image with a result of the present invention, in accordance with some embodiments, and includes two panels (a) and (b);

FIG. 5 compares an initial model and image with a result of the present invention, in accordance with some embodiments, and includes two panels (a) and (b); and

FIG. 6 compares an initial model and image with a result of the present invention, in accordance with some embodiments, and includes two panels (a) and (b); and

FIG. 7 illustrates a system for elastic full waveform inversion, in accordance with some embodiments.

Like reference numerals refer to corresponding parts throughout the drawings.

### DETAILED DESCRIPTION OF EMBODIMENTS

Described below are methods, systems, and computer readable storage media that provide a manner of seismic imaging. These embodiments are designed to generate a 3-D model of physical properties of the subsurface, including the P-wave velocity (V_{P}), S-wave velocity (V_{S}), and density (ρ) for use in seismic imaging. The present invention applies a Vp-Vs-density parametrization in elastic FWI to invert hydrophone seismic data for these subsurface earth properties. Inversion of these parameters from hydrophone seismic data is possible due to the AVA behavior of this data, which is directly related to elastic parameter contrasts across subsurface interfaces. A natural framework to implement such an inversion is clastic FWI, This is done by utilizing an adjoint-state approach that computes objective-function gradients suitable for joint simultaneous elastic inversion for Vp, Vs and density without any reference to well-log constraints. Eliminating the use of well-log constraints offers a significant advantage over standard AVA analysis derived from migrated image gathers which often relies on such constraints to obtain an accurate inversion. Inverted acoustic impedance (AI), density, and V_{P}V_{S} ratios from the present elastic FWI compare well with well-logs and standard AVA results obtained from migrated gathers, suggesting that elastic FWI is robust for the determination of elastic subsurface earth properties directly from hydrophone data.

Advantageously, those of ordinary skill in the art will appreciate, for example, that the embodiments provided herein may be utilized to generate a more accurate digital seismic image (i.e., the corrected digital seismic image). The more accurate digital seismic image may improve hydrocarbon exploration and improve hydrocarbon production. The more accurate digital seismic image may provide details of the subsurface that were illustrated poorly or not at all in traditional seismic images. Moreover, the more accurate digital seismic image may better delineate where different features begin, end, or any combination thereof. As one example, the more accurate digital seismic image may illustrate faults more accurately. As another example, assume that the more accurate digital seismic image indicates the presence of a hydrocarbon deposit. The more accurate digital seismic image may delineate more accurately the bounds of the hydrocarbon deposit so that the hydrocarbon deposit may be produced.

Those of ordinary skill in the art will appreciate, for example, that the more accurate digital seismic image may be utilized in hydrocarbon exploration and hydrocarbon production for decision making. For example, the more accurate digital seismic image may be utilized to pick a location for a wellbore. Those of ordinary skill in the art will appreciate that decisions about (a) where to drill one or more wellbores to produce the hydrocarbon deposit, (b) how many wellbores to drill to produce the hydrocarbon deposit, etc. may be made based on the more accurate digital seismic image. The more accurate digital seismic image may even be utilized to select the trajectory of each wellbore to be drilled. Moreover, if the delineation indicates a large hydrocarbon deposit, then a higher number of wellbore locations may be selected and that higher number of wellbores may be drilled, as compared to delineation indicating a smaller hydrocarbon deposit.

Those of ordinary skill in the art will appreciate, for example, that the more accurate digital seismic image may be utilized in hydrocarbon exploration and hydrocarbon production for control. For example, the more accurate digital seismic image may be utilized to steer a tool (e.g., drilling tool) to drill a wellbore. A drilling tool may be steered to drill one or more wellbores to produce the hydrocarbon deposit. Steering the tool may include drilling around or avoiding certain subsurface features (e.g., faults, salt diapirs, shale diapirs, shale ridges, pockmarks, buried channels, gas chimneys, shallow gas pockets, and slumps), drilling through certain subsurface features (e.g., hydrocarbon deposit), or any combination thereof depending on the desired outcome. As another example, the more accurate digital seismic image may be utilized for controlling flow of fluids injected into or received from the subsurface, the wellbore, or any combination thereof. As another example, the more accurate digital seismic image may be utilized for controlling flow of fluids injected into or received from at least one hydrocarbon producing zone of the subsurface. Chokes or well control devices, positioned on the surface or downhole, may be used to control the flow of fluid into and out. For example, certain subsurface features in the more accurate digital seismic image may prompt activation, deactivation, modification, or any combination thereof of the chokes or well control devices so as control the flow of fluid. Thus, the more accurate digital seismic image may be utilized to control injection rates, production rates, or any combination thereof.

Those of ordinary skill in the art will appreciate, for example, that the more accurate digital seismic image may be utilized to select completions, components, fluids, etc. for a wellbore. A variety of casing, tubing, packers, heaters, sand screens, gravel packs, items for fines migration, etc. may be selected for each wellbore to be drilled based on the more accurate digital seismic image. Furthermore, one or more recovery techniques to produce the hydrocarbon deposit may be selected based on the more accurate digital seismic image.

In short, those of ordinary skill in the art will appreciate that there are many decisions (e.g., in the context of (a) steering decisions, (b) landing decisions, (c) completion decisions, (d) engineering control systems and reservoir monitoring in the following but not limited to: Tow Streamer, Ocean Bottom Sensor, VSP, DASVSP, and imaging with both primaries and free surface multiple, etc.) to make in the hydrocarbon industry and making proper decisions based on more accurate digital seismic images should improve the likelihood of safe and reliable operations. For simplicity, the many possibilities, including wellbore location, component selection for the wellbore, recovery technique selection, controlling flow of fluid, etc., may be collectively referred to as managing a subsurface reservoir.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Seismic imaging of the subsurface is used to identify potential hydrocarbon reservoirs. Seismic data is acquired at a surface (e.g. the earth's surface, ocean's surface, or at the ocean bottom) as seismic traces which collectively make up the seismic dataset. The seismic data can be processed and inverted to obtain a 3-D model of the subsurface, for the P-wave velocity (V_{P}), the shear-wave velocity (V_{S}), and/or the density (ρ). The 3-D model may then be used by a seismic imaging method to generate an image from the seismic data. In the present invention, the inversion to obtain the velocity model is done via elastic full waveform inversion (FWI).

Earth properties such as Vp, Vs, and density influence seismic data through different mechanisms. Conventionally we associate traveltime with Vp, the P-wave velocity, for its leading-order sensitivity to kinematics. Acoustic FWI techniques used in production today often rely on kinematic time-shifts in the formulation of the residual used when recovering Vp; use of such time-shifts mitigates the effects of amplitude differences between acoustic forward-modelled data and the elastic effects present in field data. However, this mitigation typically precludes these methods from recovering elastic parameters Vs and density.

As a result, there has been significant recent interest to extend FWI elastically. Extension of FWI from acoustic to elastic not only honors the physics of wave propagation through the medium, it also distinguishes itself from acoustic FWI in the accurate modeling of reflection behavior at subsurface interfaces. Depending on what elastic-parameter contrasts are present across an interface, acoustic modeling of P-wave data using a Vp contrast alone will often be unable to explain seismic reflection amplitudes and phases across the full reflection angle range, even when the velocity is correct. This inability actually forms a critical underlying principle in standard AVO analysis, that is that the elastic amplitude and phase changes as a function of angle remain in migrated reflectivity gathers after migration. They are not removed by the acoustic modeling and Kirchhoff-reflectivity imaging condition in a typical migration algorithm, hence enabling a post-migration recovery of elastic parameters from the gathers.

In contrast, an elastic FWI that uses only hydrophone data relies on the angle-dependent behavior of the amplitudes and phases in the data to produce an elastic signature in the FWI residual, such as a least-squares residual, which occurs if the elastic model is not correct. Standard adjoint-based back projection can then, in principle, recover the elastic coefficients until the modeled hydrophone data matches the field data. The Heaviside singularities recovered in this way may be viewed as the leading order influencers to the amplitude and phase variations in angle. One might expect that the accuracy and separability of elastic parameters in an elastic FWI based on hydrophone data might be similar to that of standard AVO inversion after migration in media that are relatively simple and stratified. However, the nonlinear nature of an FWI inversion, with its improved ability to recover Heaviside-type singularities, together with appropriate parametrizations that improve parameter separation, suggests that elastic FWI may actually perform significantly better than standard AVO, particularly in areas where little well control is present.

The elastic wave equation can be written as

$$\begin{matrix}{\partial }_{t} {v}_{i} & = {σ}_{i j , j} / ρ\end{matrix} \qquad ( 1 )$$

$$\begin{matrix}{\partial }_{t} {σ}_{i j} & = {c}_{i j k l} ( {v}_{k , l} + {v}_{l , k} ) / 2 + f {δ}_{i j}\end{matrix} \qquad ( 2 )$$

where ρ is the density, c is the fourth order stiffness tensor, σ is the second order stress tensor, v is the particle velocity, and f is the diagonal pressure stress. Apply the Voigt index mapping, the forward equation can be written as

$${\partial }_{t} ( {v \atop σ} ) = ( \begin{matrix}b & 0 \\ 0 & C\end{matrix} ) ( \begin{matrix}0 & {∇}_{h} \\ {∇}_{v} & 0\end{matrix} ) ( {v \atop σ} ) + ( {0 \atop f} ) . \qquad ( 3 )$$

### Here

$$b = \frac{1}{ρ}$$

is the buoyancy, the vector σ distinguishes from its second order tensor notation only by how the index is presented, specifically,

$$( {σ}_{1} , {σ}_{2} , {σ}_{3} , {σ}_{4} , {σ}_{5} , {σ}_{6} ) = ( {σ}_{11} , {σ}_{22} , {σ}_{33} , {σ}_{23} , {σ}_{13} , {σ}_{12} ) ,$$

C is a matrix of the reduced stiffness tensor, and ∇ₕ=(∇_{d} ∇ₛ),

$${∇}_{v} = ( \begin{matrix}{∇}_{d} \\ {∇}_{s}\end{matrix} ) ,$$

where

$${∇}_{d} = ( \begin{matrix}{\partial }_{1} & 0 & 0 \\ 0 & {\partial }_{2} & 0 \\ 0 & 0 & {\partial }_{3}\end{matrix} ) , {∇}_{s} = ( \begin{matrix}0 & {\partial }_{3} & {\partial }_{2} \\ {\partial }_{3} & 0 & {\partial }_{1} \\ {\partial }_{2} & {\partial }_{1} & 0\end{matrix} ) .$$

We set the objective function to be

$$J = \frac{1}{2} {‖ S σ - {d}^{obs} ‖}^{2} - \frac{α}{2} ‖ {d}^{obs} ∘ S σ {‖}^{2} . \qquad ( 4 )$$

Here S is a sampling operator, d^{obs} is the observed data, ∥⋅∥ is an L₂ norm, ^{∘} indicates correlation, and α is a small positive real number. The stack-power term represented as the correlation is used to regulate the data residual. Let * be the convolution operator, so the residual wavefield (R) becomes

$$R = {S}^{*} ( S σ - {d}^{obs} ) - α {S}^{*} {d}^{obs} * ( {d}^{obs} ∘ S σ ) ) . \qquad ( 5 )$$

Now we let u be the adjoint-state particle velocity, t be the adjoint-state stress under the Voigt notation, and

$${\partial }_{t}^{*}$$

be the time partial derivative in reverse-time, so the adjoint-state wavefield satisfies:

$${\partial }_{t}^{*} ( \begin{matrix}u \\ τ\end{matrix} ) = - ( \begin{matrix}0 & {∇}_{h} \\ {∇}_{v} & 0\end{matrix} ) ( \begin{matrix}b & 0 \\ 0 & C\end{matrix} ) ( \begin{matrix}u \\ τ\end{matrix} ) + ( \begin{matrix}0 \\ R\end{matrix} ) \qquad ( 6 )$$

With tensor notation, equation 6 can be written as

$${\partial }_{t} {u}_{i} = {( {c}_{ijkl} {τ}_{kl} )}_{, j} \qquad ( 7 )$$

$${\partial }_{t} {τ}_{ij} = {κ}_{ij} ( {( u / ρ )}_{i , j} + {( u / ρ )}_{j , i} ) / 2 \qquad ( 8 )$$

To satisfy the final value condition, where

$${κ}_{i j} = \{ \begin{matrix}1 if i = j \\ 2 if i \neq j\end{matrix} .$$

Like σ, the vector τ and its second order tensor notation are distinguished by how the index is used. The apparent gradient for ρ and the Cᵢⱼ matrix are collected as:

$$\partial J / \partial b = \int dt {σ}_{ij , j} {u}_{i} \qquad ( 9 )$$

$$\partial J / \partial {C}_{ij} = \int dt {κ}_{ij} ( D {v}_{i} {τ}_{j} + {Dv}_{j} {τ}_{i} ) / 2 \qquad ( 10 )$$

and Dv is defined as

$${Dv}_{1} = {v}_{1 , 1} \qquad ( 11 )$$

$${Dv}_{2} = {v}_{2 , 2} \qquad ( 12 )$$

$${Dv}_{3} = {v}_{3 , 3} \qquad ( 13 )$$

$${Dv}_{4} = {v}_{2 , 3} + {v}_{3 , 2} \qquad ( 14 )$$

$${Dv}_{5} = {v}_{1 , 3} + {v}_{3 , 1} \qquad ( 15 )$$

$${Dv}_{6} = {v}_{1 , 2} + {v}_{2 , 1} \qquad ( 16 )$$

By the chain rule, the gradient to density (ρ) can be written as

$$\frac{\partial J}{\partial ρ} = - \frac{1}{{ρ}^{2}} \frac{\partial J}{\partial b} + \frac{\partial J}{\partial {C}_{ij}} \frac{\partial {C}_{ij}}{\partial ρ} \qquad ( 17 )$$

The gradient to V_{P} and V_{S} are obtained via the chain rule as

$$\frac{\partial J}{\partial {V}_{p}} = \frac{\partial J}{\partial {C}_{ij}} \frac{\partial {C}_{ij}}{\partial {V}_{p}} \qquad ( 18 )$$

$$\frac{\partial J}{\partial {V}_{s}} = \frac{\partial J}{\partial {C}_{ij}} \frac{\partial {C}_{ij}}{\partial {V}_{s}} \qquad ( 19 )$$

The objective function of equation (4) and the gradients in ρ, Vₚ, Vₛ, as represented by equations (17), (18), (19), respectively, are employed to build the elastic FWI iterative scheme.

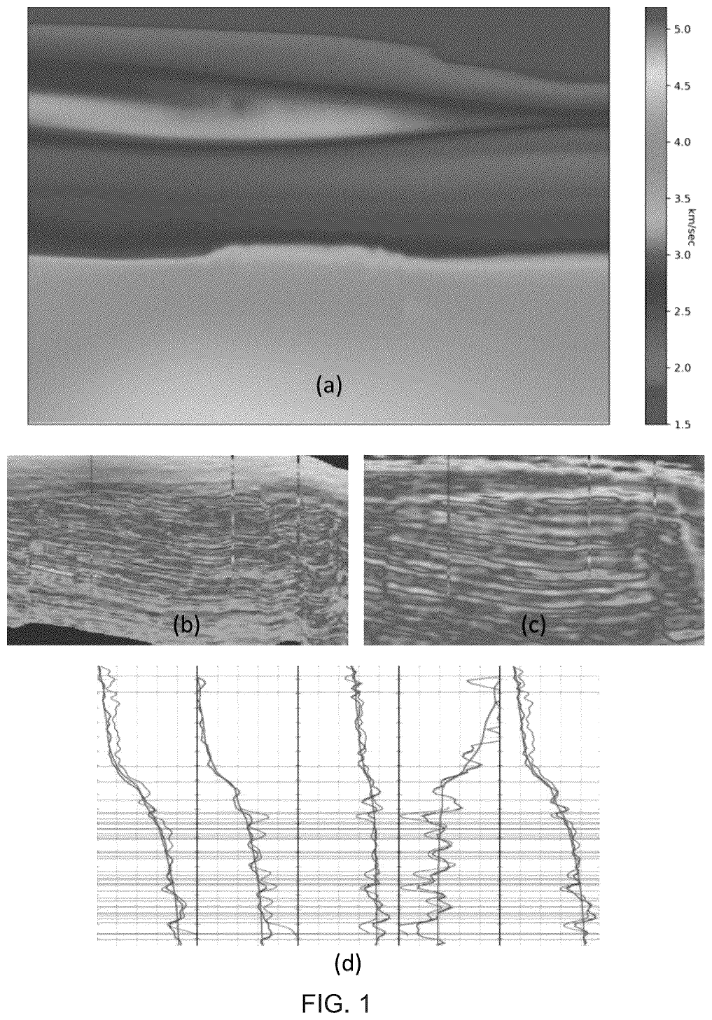

FIGS. 1-6 show examples of the method described above applied to a hydrophone dataset. The initial V_{P} velocity model, as shown in FIG. 1 panel (a), has no structures with large wavenumbers (high frequency). The initial density model was derived using the Gardner relation based on the initial V_{P} velocity model. The water density is set to unity (1). The initial Vs model is derived according to V_{S}=V_{P}/1.7 in the sediment and V_{S}=0 in the water. A bootstrapping frequency scheme is used to raise the frequency band gradually from an initial peak frequency of 7 Hz to a final peak frequency of 25 Hz, with the final amplitude being 20 dB down from the peak at 30 Hz.

We compare our results against a standard geostatistical inversion. The high frequency character of the geostatistical inversion comes from the utilization of a production high frequency (≥70 Hz) Kirchhoff image together with gathers and well-log constraints. It's worth noting that the present elastic FWI does not use any well information. The statistical inversion was conducted to derive Vp, Vs, VpVs ratio, and density, which are currently considered as the best knowledge we have for the earth parameters in the area of investigation. In FIG. 1, we compare at reservoir scale the geostatistical inverted Vp (FIG. 1 panel (b)) and the inverted Vp from elastic FWI (FIG. 1 panel (c)). The Vp model from elastic FWI captures faults and major events which are in good one-to-one agreement with the geo-statistical Vp, despite the FWI being run to lower frequency. From left to right, FIG. 1 panel (d) shows the Vp-log, Vs-log, density-log, VpVs-ratio-log and the acoustic impedance log, overlaid with initial and final depth profiles extracted from the corresponding parameters in the elastic FWI model. The magenta, blue and the black are, respectively, the initial and final results from elastic FWI, and a well log, wavenumber-filtered to match the FWI spectrum. In general, there is close agreement with well-log data when comparing with elastic FWI results.

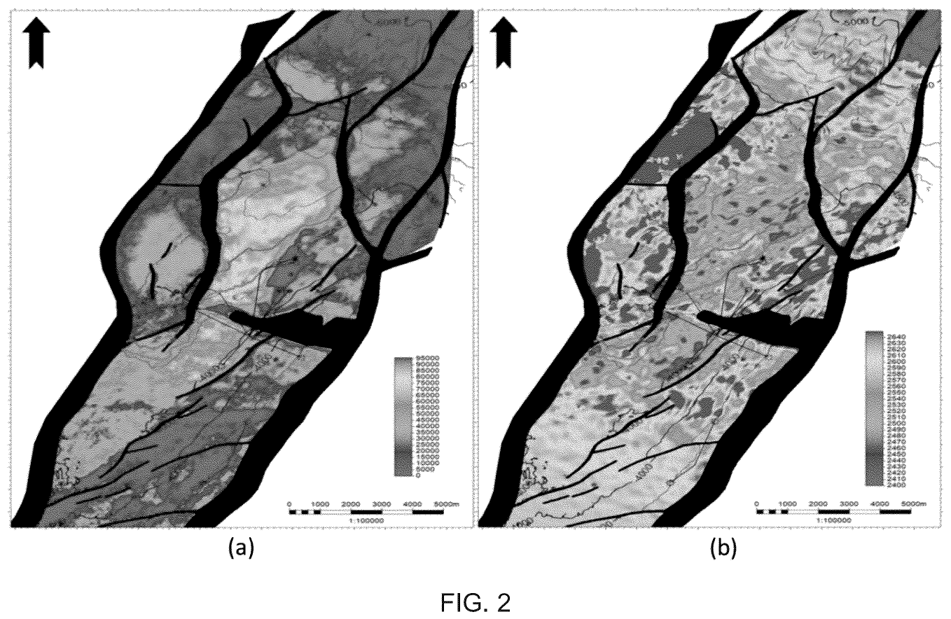

Although density results from the geo-statistical inversion proved to be unreliable, a rough qualitative estimate of density can be obtained from conventional imaging from the far offset stack, as it tends to negatively correlate with density variations. High far offset stack amplitudes are associated with low density and vice-versa. FIG. 2 panel (a) compares the far offset stack amplitude with FIG. 2 panel (b), the density inversion depth slice from elastic FWI. Blue color corresponds to low values while red and magenta correspond to high. In comparing the two images, it is clear that they negatively correlate on a long-wavelength scale, with blues in the far-offset amplitude plot correlating well with red and magenta in the FWI density, particularly on the left side of the section.

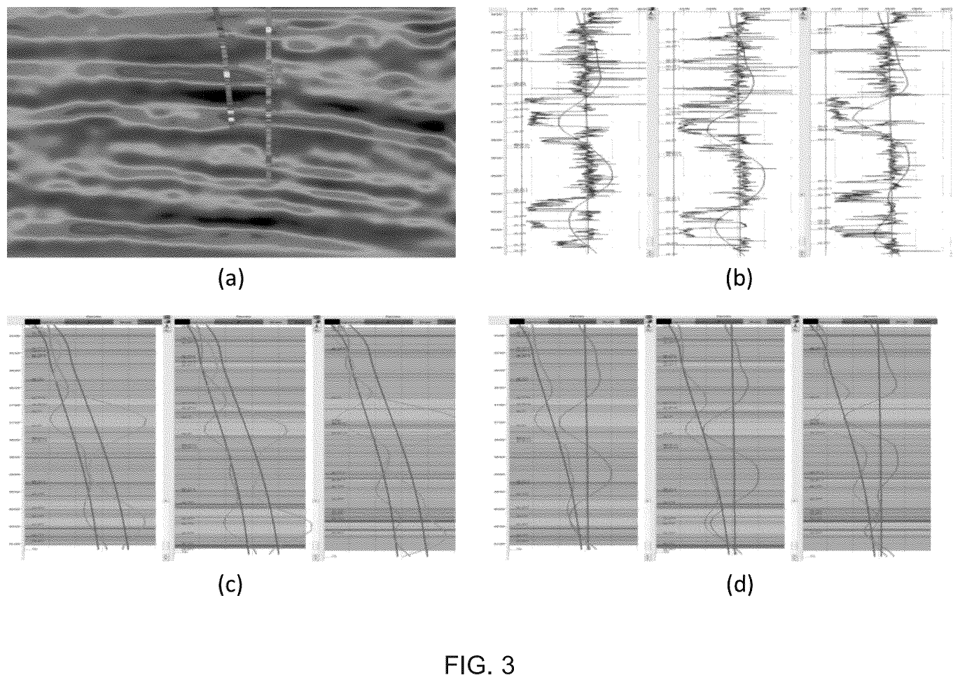

To examine density at the reservoir scale, we show the inverted density in FIG. 3 panel (a) overlaid with density well-logs. We observe that the location and amplitude of density variations correlate well with the density log despite the well log having higher resolution. As shown in FIG. 3 panel (b), the signature on the well-log plot associated with a high quality sand (of extra low density) coincides with the low-density anomaly from inverted FWI density. This density result suggests that elastic FWI is effective in recovering band-limited density directly from surface seismic data, without any well-log data or constraint being used.

Hydrocarbon indicators are usually tied to sands which typically have low density values. Rock physics predicts that high-quality sands are also associated with high values of Vs and low values of Vp. To be sure that the elastic FWI is not accidentally producing low density values at locations of high-quality sands, we make facies plots of sands overlaid with depth profiles extracted from inverted Vs and Vp. Shown in FIG. 3 panel (c), the depth profiles extracted from the inverted density model and the Vs model are plotted in magenta and in green, respectively. Their initial depth profiles before inversion are recorded as smooth curves in blue. The shear velocities are high at the cyan facies characterized by the high-quality sands. A similar overlay of facies of sand and Vp are shown in FIG. 3 panel (d), where, again, the depth profile of the inverted density is plotted in magenta, but the inverted Vp is plotted in red, and their initial depth profiles are depicted as smooth curves in blue. The cyan-colored high-quality sands coincide with low Vp values. The parity comparison between FIG. 3 panel (c) and FIG. 3 panel (d) clearly demonstrates the correspondence with high quality sands, low density, low Vp but high Vs, a unique material attribute combination that completely agrees with the prediction of rock physics. This confirms that the sensitivity in Vp, Vs, and density to clastic reflection parameters is sufficient to inversely determine these parameters from surface acquired reflection data.

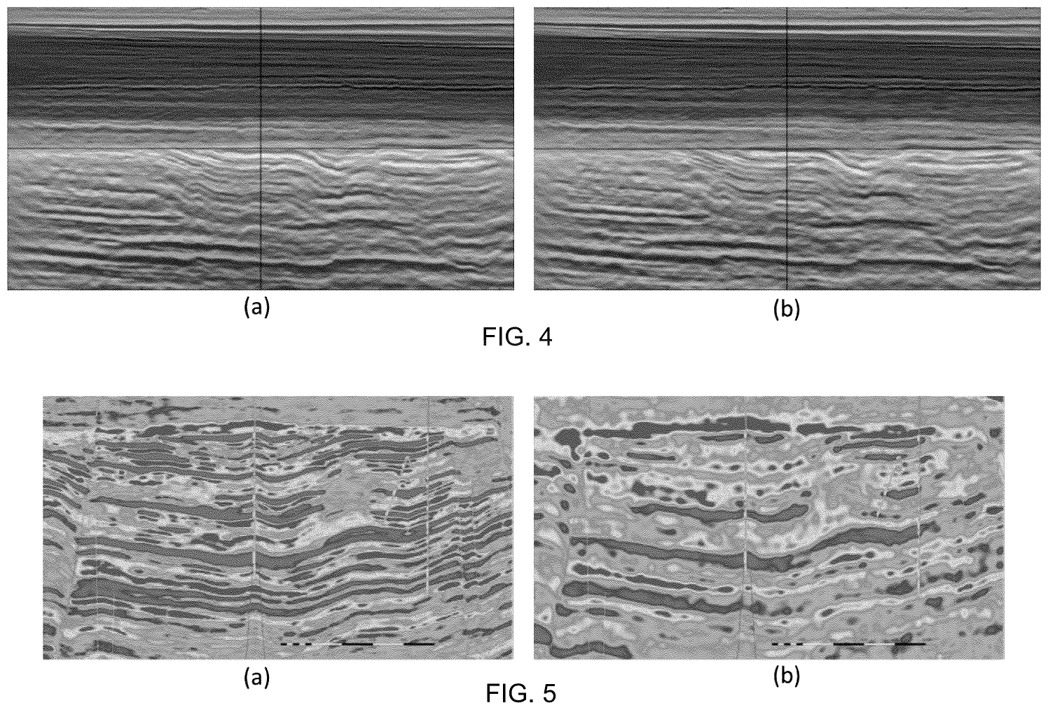

We close the FWI density examination by showing the overlaid seismic image and density. The initial image overlaid with the initial density model is shown in FIG. 4 panel (a). No other additional information for density recovery in the FWI was provided. FIG. 4 panel (b) shows the final seismic image overlaid with the final density model. The final seismic image is migrated using the final Vp model from the elastic FWI. The prospect area is well correlated with the output density model by the low amplitude anomalies. At the same time, the geometric definition of the prospect is also slightly sharper in the FWI result.

The reservoir-scale parity comparison of the geo-statistical inversion of VpVs ratio and the VpVs ratio obtained from dividing the Vp model by the Vs model from elastic FWI is shown in FIG. 5. FIG. 5 panel (a) is the statistically derived VpVs ratio based on a Kirchhoff image at 70 Hz with utilization of well information, which is considered by us the best knowledge of the VpVs ratio of the studied area. The VpVs ratio obtained by taking the ratio of output Vp model and the Vs model from elastic FWI is shown in FIG. 5 panel (b). The correspondence between FIG. 5 panel (a) and FIG. 5 panel (b) is clear not only in event positioning but also in amplitude. One area where elastic FWI outperforms geostatistical inversion is at the position of the small well at the upper right corner in (FIG. 5 panel (b)). Well information from this well was not provided to the geostatistical inversion, and as a result, one can see in FIG. 5 panel (a) that the VpVs ratio from statistical inversion does not follow the well-log result at the location of this well. However, the VpVs ratio from elastic FWI follows well-log closely within the limits of its bandwidth.

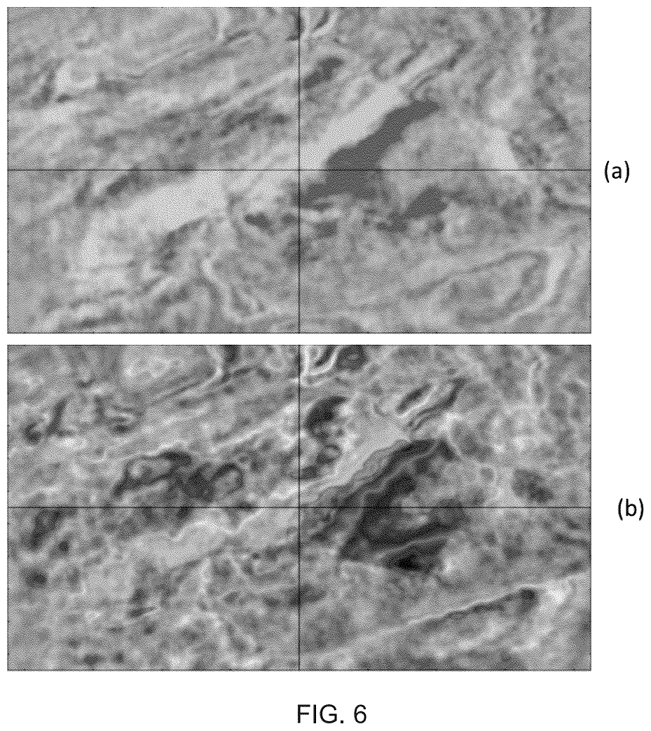

As a further assessment of the FWI result we show the initial image depth slice, migrated using initial Vp model over-laid with the initial VpVs ratio in FIG. 6 panel (a). Again, all the structures recovered here are recovered directly from the seismic, since the initial Vs model was simply the initial Vp model scaled by a constant. The same overlay but using the final im-age and the final VpVs ratio from the elastic FWI is shown in FIG. 6 panel (b). We are pleased to see that the channel is well captured in the VpVs ratio result. Most other structures also correlate well with the inverted VpVs ratio. There is an abundance of extra interpretable information centered around the prospect area that are unseen by conventional seismic but are revealed from information inverted by elastic FWI.

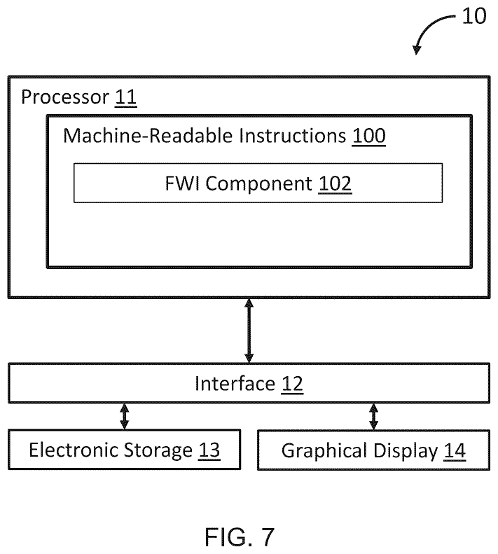

The methods and systems of the present disclosure may be implemented by a system and/or in a system, such as a system 10 shown in FIG. 7. The system 10 may include one or more of a processor 11, an interface 12 (e.g., bus, wireless interface), an electronic storage 13, a graphical display 14, and/or other components. The processor 11 is configured to receive an initial subsurface model and a seismic dataset and perform operations to generate an updated subsurface model.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to seismic data, subsurface models, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 7 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to seismic data, subsurface models, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate full waveform inversion. The machine-readable instructions 100 may include one or more computer program components. The machine-readable instructions 100 may include a FWI component 102 and/or other computer program components.

It should be appreciated that although computer program components are illustrated in FIG. 7 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for case of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the FWI component 102 may be configured to receive an earth model including properties such as seismic velocity (P-wave velocity and/or S-wave velocity), density information, and/or other subsurface properties to generate modeled seismic data. FWI component 102 also receives hydrophone seismic data. The FWI component performs the operations described above to generate an updated earth model which can be used for seismic imaging,

The updated earth models and/or seismic images generated by machine-readable instructions 100 are graphically displayed as a three-dimensional map of the physical properties of the earth's subsurface by graphical display 14. These three-dimensional maps may also be stored in electronic storage 13.

The novel FWI used herein did not use any prior well-log information. Our recovery of Vp, density, and VpVs ratio suggest that such an inversion can be relatively robust, and the results obtained in general compare quite favorably to standard geostatistical results, and appear to outperform it in the recovery of density. This suggests that despite the computational cost, elastic FWI may be an effective tool for elastic parameter recovery in exploration or step-out settings, where limited well-log information is available. In addition, clastic FWI may be used to not only reconstruct elastic properties, but may also provide additional parameter volumes that can be used in the interpretation and identification of hydrocarbon reservoirs.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for generating a 3D map of physical properties of a subsurface volume of interest, comprising:
a. receiving, at one or more computer processors, a hydrophone seismic dataset representative of the subsurface volume of interest and an initial earth model;
b. performing, via the one or more processors, elastic full waveform inversion using the hydrophone seismic dataset to generate an updated earth model, wherein the elastic full waveform inversion uses a P-wave velocity (Vp)-S-wave velocity (Vs)-density (ρ) parameterization;
c. generating a graphical representation of a 3D map of physical properties of the updated earth model; and
d. displaying the graphical representation on a graphical display.

2. The method of claim 1 further comprising performing seismic imaging of the hydrophone seismic dataset using the updated earth model to create a seismic image.

3. The method of claim 2 further comprising using the seismic image and the updated earth model to select locations to drill at least one well in order to extract hydrocarbons.

4. The method of claim 1 wherein the Vp-Vs-density parameterization uses an objective function J
$$J = \frac{1}{2} {‖ S σ - {d}^{obs} ‖}^{2} - \frac{α}{2} ‖ {d}^{obs} ∘ S σ {‖}^{2}$$
$$and$$
$$\frac{\partial J}{\partial ρ} = - \frac{1}{{ρ}^{2}} \frac{\partial J}{\partial b} + \frac{\partial J}{\partial {C}_{ij}} \frac{\partial {C}_{ij}}{\partial ρ}$$
where d^{obs} is the hydrophone seismic dataset, S is a sampling operator, σ is a second order stress tensor, ∥⋅∥ is an L₂ norm, ^{∘} indicates correlation, α is a small positive real number,
$$\frac{\partial J}{\partial {V}_{p}} = \frac{\partial J}{\partial {C}_{ij}} \frac{\partial {C}_{ij}}{\partial {V}_{p}}$$
$$\frac{\partial J}{\partial {V}_{s}} = \frac{\partial J}{\partial {C}_{ij}} \frac{\partial {C}_{ij}}{\partial {V}_{s}}$$
is buoyancy, and Cᵢⱼ is a reduced stiffness tensor.

5. A computer system, comprising:
one or more processors;
memory; and one or more programs, wherein the one or more programs are stored in the memory and configured to be executed by the one or more processors, the one or more programs including instructions that when executed by the one or more processors cause the computer system to:
a. receive, at one or more processors, a seismic dataset representative of a subsurface volume of interest and an initial earth model;
b. perform, via the one or more processors, elastic full waveform inversion using the hydrophone seismic dataset to generate an updated earth model, wherein the elastic full waveform inversion uses a P-wave velocity (Vp)-S-wave velocity (Vs)-density (ρ) parameterization;
c. generate, via the one or more processors, a graphical representation of a 3D map of physical properties of the updated earth model; and
d. display the graphical representation on a graphical display.

6. The computer system of claim 4 further including instructions that when executed by the one or more processors cause the computer system to perform seismic imaging of the hydrophone seismic dataset using the updated earth model to create a seismic image.
